(19) United States
(12) Patent Application Publication
(10) Pub. No.: US 2018/0336501 A1
(43) Pub. Date: Nov. 22, 2018

(54) MULTI-OBJECTIVE OPTIMIZATION OF JOB SEARCH RANKINGS

(71) Applicant: LinkedIn Corporation, Sunnyvale, CA (US)

(72) Inventors: Benjamin Hoan Le, San Jose, CA (US); Dhruv Arya, Sunnyvale, CA (US); Aman Grover, Sunnyvale, CA (US); Shaunak Chatterjee, Sunnyvale, CA (US)

(21) Appl. No.: 15/607,296

(22) Filed: May 26, 2017

Related U.S. Application Data
(60) Provisional application No. 62/507,620, filed on May 17, 2017.

(51) Int. Cl. G06Q 10/06; G06Q 10/10; G06F 17/30; G06Q 50/00

(52) U.S. Cl. CPC G06Q 10/06; G06Q 50/01; G06F 17/30867; G06Q 10/1053

(57) ABSTRACT

A system, a machine-readable storage medium storing instructions, and a computer-implemented method are described herein are directed to a Jobs Optimization Engine. The Jobs Optimization Engine accesses at least one respective apply probability that corresponds to a given job post from a plurality of job posts, each respective apply probability represents a likelihood that the target member account will apply to the given job post. The Jobs Optimization Engine determines, according to an input context and the at least one respective apply probability, a respective boost factor for each given job post based on including the given job post in a select listing of job posts that satisfies (i) a job post diversity requirement and (ii) a potential revenue target that can be generated by the select listing of job posts. Based on satisfaction of the job post diversity requirement and the potential revenue target, the Jobs Optimization Engine causes display of the select listing of job posts to the target member account in the social network service, wherein a first job post is ranked in the select listing according to a corresponding boost factor.

### CROSS-REFERENCE TO RELATED APPLICATION

This application claims the benefit of priority to U.S. Provisional Patent Application entitled “Multi-Objective Optimization of Job Search Rankings,” Ser. No. 62/507,620, filed May 17, 2017, which is hereby incorporated herein by reference in its entirety.

### TECHNICAL FIELD

The subject matter disclosed herein generally relates to the technical field of special-purpose machines that identify relevant content including software-configured computerized variants of such special-purpose machines and improvements to such variants, and to the technologies by which such special-purpose machines become improved compared to other special-purpose machines that identify relevant content.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment:

FIG. 2 is a block diagram showing functional components of a professional social network within a networked system, in accordance with an example embodiment;

FIG. 3 is a block diagram showing example components of a Jobs Optimization Engine, according to some embodiments.

FIG. 4 is a block diagram showing a data flow in a Jobs Optimization Engine, according to example embodiments;

FIG. 5 is a block diagram representing the operations of a Jobs Optimization Engine, according to an example embodiment.

FIG. 6 is a flowchart illustrating an example method, according to various embodiments;

FIG. 7 is a block diagram of an example computer system on which operations, actions and methodologies described herein may be executed, in accordance with an example embodiment.

### DETAILED DESCRIPTION

The present disclosure describes methods and systems for identifying relevant content in a professional social networking service (also referred to herein as a “professional social network,” “social network” or a “social network service”). In the following description, for purposes of explanation, numerous specific details are set forth in order to provide a thorough understanding of the various aspects of different embodiments of the subject matter described herein. It will be evident, however, to one skilled in the art, that the subject matter described herein may be practiced without all of the specific details.

A system, a machine-readable storage medium storing instructions, and a computer-implemented method are described herein are directed to a Jobs Optimization Engine. The Jobs Optimization Engine accesses at least one respective apply probability that corresponds to a given job post from a plurality of job posts, each respective apply probability represents a likelihood that the target member account will apply to the given job post. The Jobs Optimization Engine determines, according to an input context and the at least one respective apply probability, a respective boost factor for each given job post based on including the given job post in a select listing of job posts that satisfies constraints, such as (i) a job post diversity requirement and (ii) a potential revenue target that can be generated by the select listing of job posts. Based on satisfaction of the job post diversity requirement and the potential revenue target constraints, the Jobs Optimization Engine causes display of the select listing of job posts to the target member account in the social network service, wherein a first job post is ranked in the select listing according to a corresponding boost factor. It is understood that there can be any type and any number of constraints. Certain constraints can also be a desired number of views of one or more premium job posts, a desired number of views of one or more basic job posts, a desired average number of job applications to premium job posts, a desired average number of job applications to basic job posts, etc.

In a social network service, customer member accounts (“customer”) upload one or more job posts to which applicant member accounts (“member account”) of the social network service can apply. Some job posts are premium job posts uploaded for a fee while other job posts are basic job posts uploaded for free. Maximizing member account satisfaction and customer satisfaction unfortunately tradeoff with each other, in that showing more premium jobs postings may shuffle the organic rankings (or relevance-based job post rankings with respect a given member account) slightly which naturally brings down member account engagement. That is, over-populating a listing of job posts for a target member account with premium job posts may result in less target member account engagement. Optimizing for the right tradeoff between member account and customer satisfaction in job search is the solution provided by the Jobs Optimization Engine as described herein. Another objective met by Jobs Optimization Engine is to achieve an applications balance, such as by achieving a state in which received job post applications are distributed relatively uniformly to all job posts and that customer accounts that uploaded those job posts receive a consistent level of qualified applicants—while still maintaining member account satisfaction and customer satisfaction jointly as member accounts are displayed listing of job posts that includes a diversity of job posts to which they are more likely to submit applications.

The Jobs Optimization Engine solves this multi-objective optimization problem as a constrained optimization problem that maximizes the number of job applications submitted by member accounts subject to one or more constraints. For example, a first constraint can be a job post diversity requirement for requiring a pre-defined ratio between displaying (or received applications for) premium job posts and basic job posts. By processing Lagrangians and solving a dual problem, an embodiment of the Jobs Optimization Engine learns a respective boosting factor for premium job posts. The boost factor adjusts the relevance rank of a corresponding job post that is included in a select listing of job posts that is to be displayed to a target member account. The boost factors ensure that premium job posts will be included in the select listing of job posts to an extent that will satisfy customers and generate revenue—while not crowding out available listing slots for basic job posts that are highly relevant to the target member account.

It is understood that various embodiments described herein include encoded instructions that comprise operations to generate a user interface(s) and various user interface elements. The user interface and the various user interface elements can be displayed to be representative of any type of data, operation, and calculation result described herein. In addition, the user interface and various user interface elements are generated by the Jobs Optimization Engine for display on a computing device, a server computing device, a mobile computing device, etc.

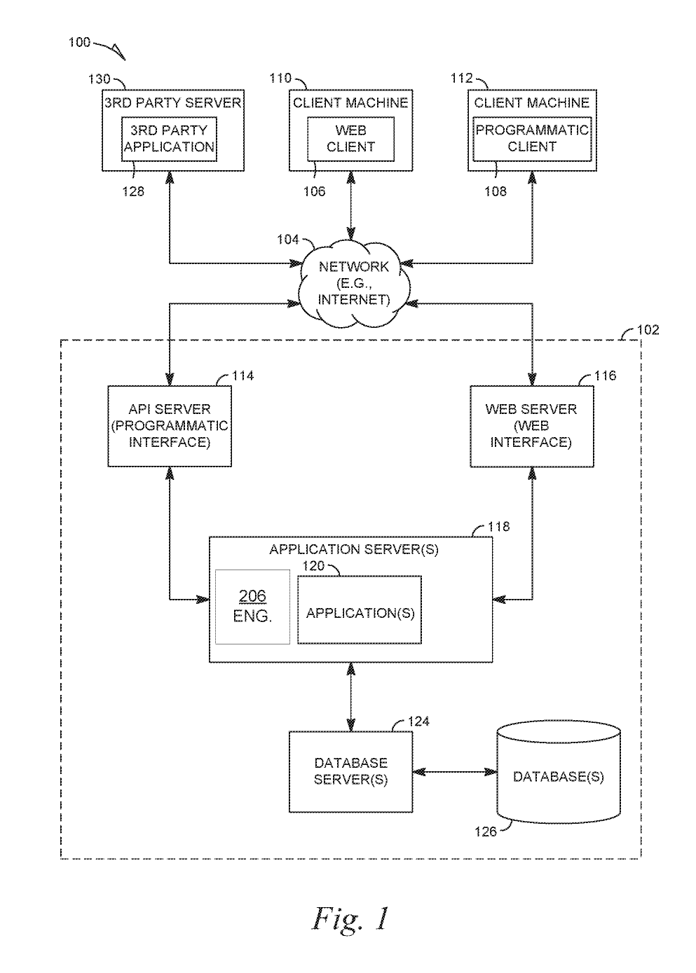

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

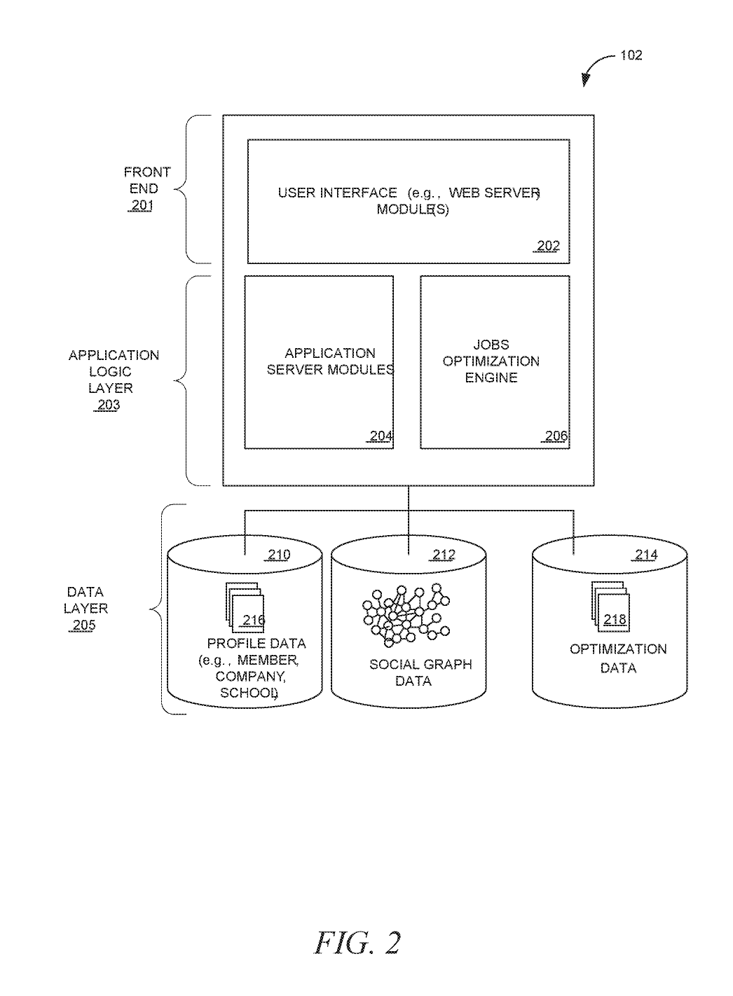

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

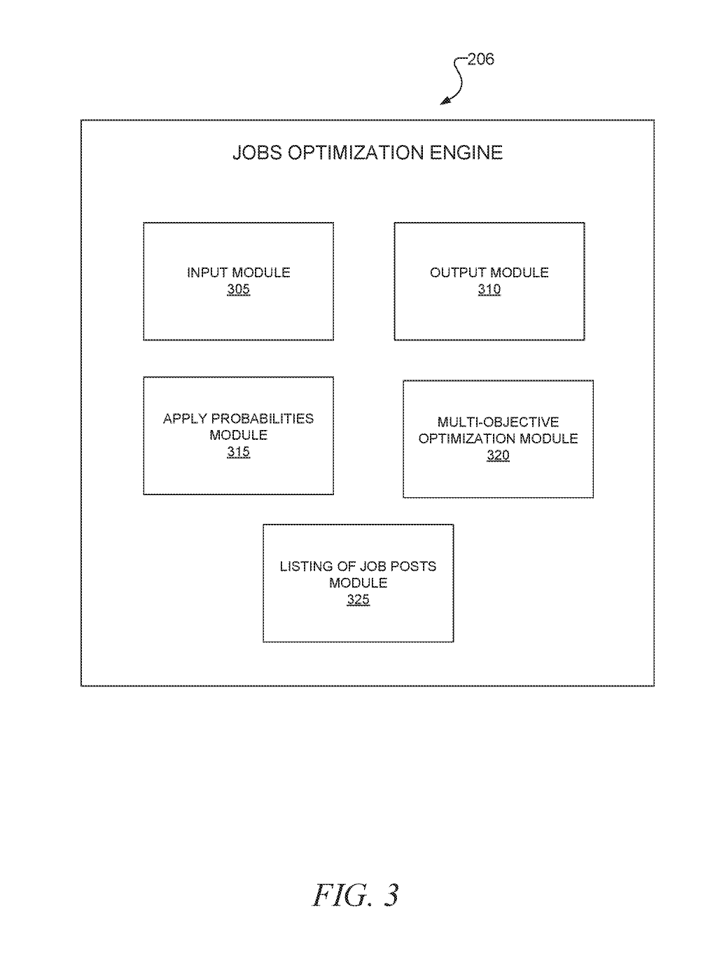

The data in the data layer 205 may be accessed, used, and adjusted by the Jobs Optimization Engine 206 as will be described in more detail below in conjunction with FIGS. 3-7. Although the Jobs Optimization Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure. In one embodiment, the data layer 205 further includes a database 214 that includes optimizations data 218, such as search queries, identifier of a target member account, one or more apply probabilities and one or more encoded instructions representing calculations of a multi-objective optimization algorithm.

FIG. 3 is a block diagram showing example components of a Jobs Optimization Engine 206, according to some embodiments.

The input module 305 is a hardware-implemented module that controls, manages and stores information related to any inputs from one or more components of system 102 as illustrated in FIG. 1 and FIG. 2. In various embodiments, the inputs include an input context and pre-calculated apply probabilities.

The output module 310 is a hardware-implemented module that controls, manages and stores information related to which sends any outputs to one or more components of system 100 of FIG. 1 (e.g., one or more client devices 110, 112, third party server 130, etc.). In some embodiments, the output is one or more serve probabilities for respective job posts with respect to a target member account and a select listing of job posts.

The apply probabilities module 315 is a hardware implemented module which manages, controls, stores, and accesses information related to calculating and allowing for access of one or more apply probabilities. A machine learning data model is executed to determine an apply probability of a given member account with respect to a respective job post. The machine learning data model calculates the apply probability based on presence of various types of member account features in the profile data of the given member account and presence of various types of job post features in social network data associated with the respective job post. In some embodiments, the machine learning data model can be a logistic regression model for calculating apply probabilities for job posts with respect to one or more member accounts of the social network service. The apply probabilities module 315 also provides access to the pre-calculated apply probabilities for use as input data.

The multi-objective optimization module 320 is a hardware implemented module which manages, controls, stores, and accesses information related to executing a multi-objective optimization algorithm with respect to an input context and one or more apply probabilities. The multi-objective optimization module 320 returns one or more boost factors for respective premium job posts. A boost factor for a premium job post is a value that represents an extent of a bias that is required for serving the premium job in a select listing of job posts to the target member account. The bias represented by the boost factor, and the subsequent boosted ranking of the corresponding job posts, satisfies the constrained optimization problem in maximizing applications to all job posts yet making ensuring premium jobs still receiving a desired level percentage of overall traffic.

The listing of job posts module 325 is a hardware implemented module which manages, controls, stores, and accesses information related to generating a select listing of job posts. The listing of job posts module 330 further boosts a rank of one or more premium type job posts in the select listing of job posts, where the boost factor for one or more of the premium type of job posts is determined by the multi-objective optimization algorithm. The listing of job posts module 330 returns as data output the select listing of job posts, wherein a ranking of one or more premium type of job posts in the select listing is adjusted according to a respective boost factor.

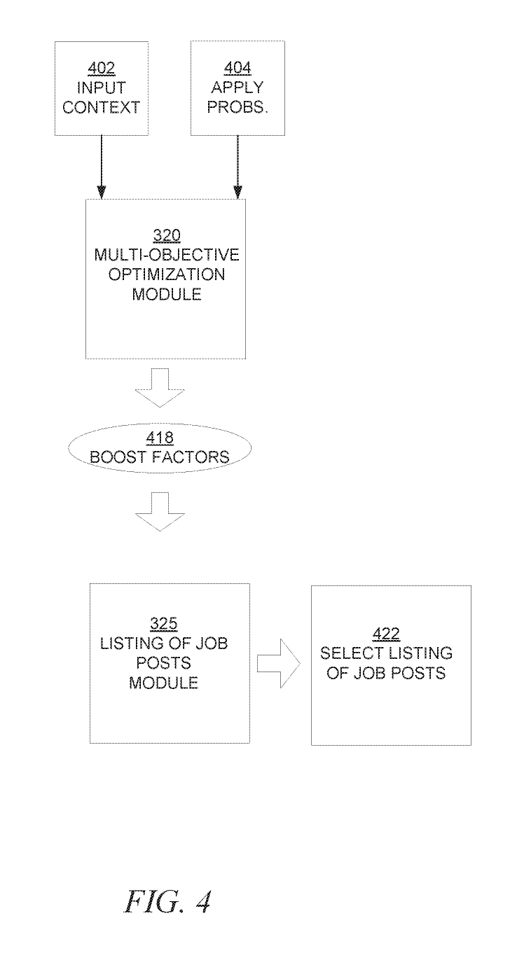

FIG. 4 is a block diagram showing a data flow in a Jobs Optimization Engine 206, according to an example embodiment. The data flow may be implemented by one or more of the modules illustrated in FIG. 3, and is discussed by way of reference thereto.

According to various embodiments, the Jobs Optimization Engine 206 receives an identification (and/or data profile attributes) of a target member account from a plurality of member accounts in a social network service, a search query provided to the social network service by the target member account and a plurality of apply probabilities that have already been pre-calculated. For example, a search query can be one or more keywords provided by the target member account. For example, a search query can be a most recent group of search query keywords provided by the target member account during a current social network session. Therefore, data input into the Jobs Optimization Engine 206 is an input context (“C′”) 402 comprising identification (and/or one or more profile attributes) of the target member account and a search query. The data input also includes accessing one or more of the plurality of respective apply probabilities 404 for one or more job posts. Although not illustrated, the constraints (i.e. a job post diversity requirement, a potential revenue target) of the multi-objective optimization algorithm can also be considered to be data input as well.

An apply probability represents a likelihood that a given member account will apply to a job post (“jᵢ”). For example, an apply probability for a particular job post is a pre-calculated value representing a likelihood that the target member account will apply to the particular job post. It is understood that the social network service can have a plurality of active job posts (“j₁ . . . jᵢ”). As such, a respective apply probability is pre-calculated for each active job post with respect to the target member account. It is further understood that, since there are a plurality of member accounts in the social network service, a respective apply probability is pre-calculated for each active job post with respect to each member account. That is, a second apply probability is pre-calculated for the particular job post with respect to a second member account and a third apply probability is pre-calculated for the particular job post with respect to a third member account. It is understood that the second and third apply probabilities may or may not be the same value.

It is understood that a machine learning data model is represented according to one more encoded instructions that, when executed, perform calculations to determine apply probabilities for job posts with respect to one or more member accounts. The machine learning data model has one or more pre-defined member account features and one or more pre-defined job post features used to determine the relevance of a job post to a member account. In one example, the machine learning data model can be a logistic regression model.

The Jobs Optimization Engine 206 determines the data output (i.e. the one or more boost factors 418, the select listing of job posts 422) according to a multi-objective optimization algorithm in order to allow for the trading off of multiple, potentially conflicting objectives against each other. A conflicting objective is observed due to the presence of basic job posts (i.e. job posts uploaded to the social network service for free) and premium job posts (i.e. job posts uploaded to the social network service by consumer accounts for a fee). That is, a greater amount of revenue can be generated by prioritizing display of premium job posts to the target member account.

However, a listing of job posts with a threshold amount (or threshold ratio) of a diversity of premium and basic job posts (i.e. a certain percentage of premium job posts and a certain percentage of basic job posts) ensures that the select listing of job posts as a whole will most likely be more relevant to the target member account than a listing of job posts that is over-populated with the premium job posts. A diversity of premium and basic job posts in a select listing of job posts likely results in the job posts receiving a desired amount of job applications from various member accounts—regardless of whether the job posts are premium or basic.

Therefore, an optimal listing of job posts will have a first number of select premium job posts that have a high likelihood of being applied to by the target member account and a second number basic job posts that are highly relevant to the target member account. Inclusion of the select premium job posts ensures that a likelihood that those consumer accounts that paid to upload those premium job posts will receive a desired number applicants.

It is understood that a first stage of data output of the Jobs Optimization Engine 206 is a respective boost factor for one or more premium job posts. For example, a first boost factor for a first premium job post represents how much a relevance ranking of the first premium job post needs to be boosted (i.e. increased) in a listing of job posts to create a select listing of job posts. By including boosted premium job posts, the select listing of job posts thereby will satisfy one or more constraints of the multi-objective optimization problem. The select listing of job posts is a second stage of data output of the Jobs Optimization Engine 206.

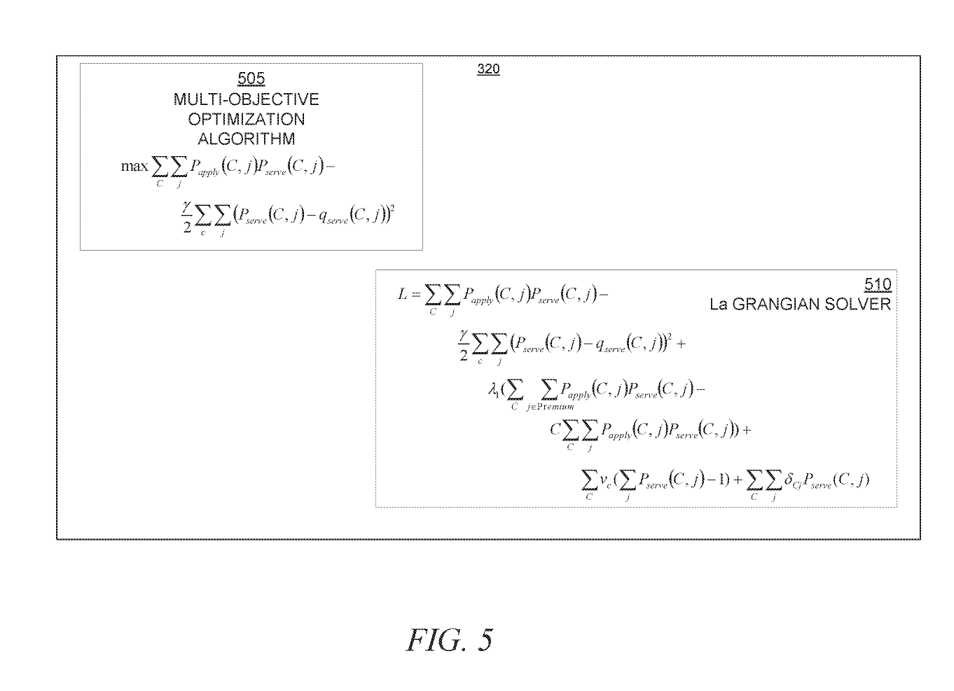

FIG. 5 is a block diagram representing the operations of a Jobs Optimization Engine 206, according to an example embodiment.

The multi-objective optimization module 320 includes one or more encoded instructions that represent a formulation for a multi-objective optimization algorithm 505 to be solved by the Jobs Optimization Engine 206. In the multi-objective optimization algorithm 505, C represents the input context and j represents a particular job post. P_{apply} represents a probability a target member account will apply to a particular job post given a certain input context and the particular job post. Pₛₑᵣᵥₑ represents a probability the particular job post will be displayed to the target member account given the certain input context. qₛₑᵣᵥₑ represents a prior serving plan for displaying job posts that is intended to ensure that the select listing of job posts does not diverge beyond a threshold extent from the prior serving plan. Hence, qₛₑᵣᵥₑ is a regularlizer variable and offers some form of control.

The multi-objective optimization module 320 includes one or more encoded instructions that represent a formulation of a LaGrangian equation 510 that returns a dual variable for each constraint. A dual variable is utilized by the the Jobs Optimization Engine 206 as a respective boosting factor (see λ₁). The formulation of the LaGrangian equation 510 includes γ, which represents a parameter that controls how much regulation occurs between Pₛₑᵣᵥₑ and qₛₑᵣᵥₑ. Stated differently, γ enforces how different Pₛₑᵣᵥₑ and qₛₑᵣᵥₑ can be from each other. The formulation of the LaGrangian equation 510 includes O_{cj}, which enforces a requirement that all values for Pₛₑᵣᵥₑ are not negative. The variable Vc enforces a requirement that all values for Pₛₑᵣᵥₑ for job posts given an input context will add up to 1. The LaGrangian equation 510 solves a boosting factor for each constraint that is under consideration (i.e. job post diversity requirement, potential revenue target).

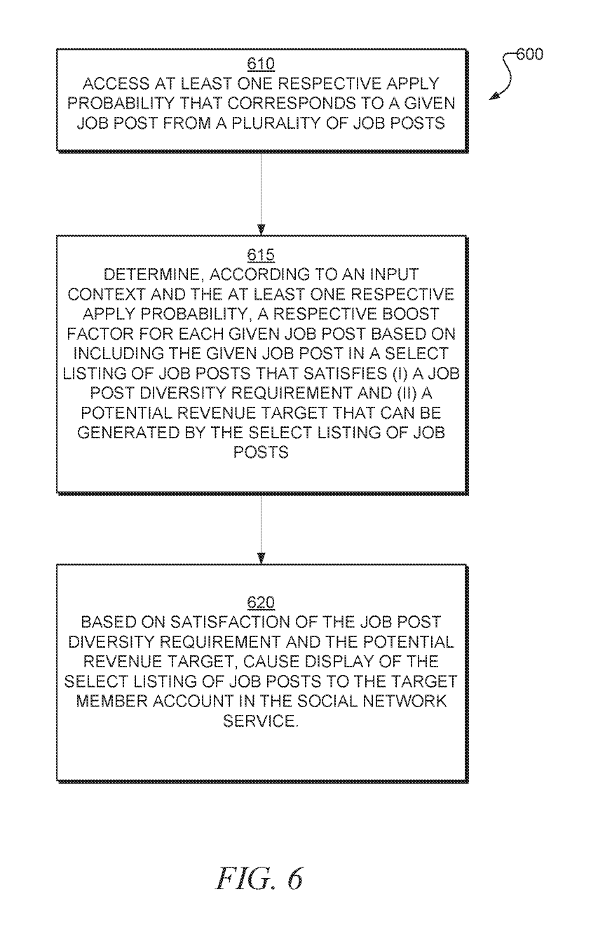

FIG. 6 is a flowchart 600 illustrating an example method, according to various embodiments.

At operation 610, the Jobs Optimization Engine 206 accesses at least one respective apply probability that corresponds to a given job post from a plurality of job posts. For example, a first apply probability represents a likelihood that the target member account will apply to a first job post and a second apply probability represents a likelihood that the target member account will apply to a second job post.

At operation 615, the Jobs Optimization Engine 206 determines, according to an input context and the at least one respective apply probability, a respective boost factor for each given job post based on including the given job post in a select listing of job posts that satisfies (i) a job post diversity requirement and (ii) a potential revenue target that can be generated by the select listing of job posts. The input context comprises one or more profile data attributes of the target member account and at least one keyword of a search query submitted by the target member account. In addition, a respective boost factor represents an extent of rank adjustment to be applied to a current rank of a premium type of job post included in the select listing of job posts. For example, a relevance rank of a first premium job post can be at a 12^{th} position in a listing of relevant job posts. The Jobs Optimization Engine 206 applies a boost factor to the listing of relevant job posts, which boosts the first premium job post up to the 8^{th} position. The Jobs Optimization Engine 206 updates the listing of relevant job posts to place the first premium job post at the 8^{th} position. The updated listing of relevant job posts is the output select listing of job posts. It is understood that each premium job post can have its own specific boost factor or a single boost factor can apply to all premium job posts.

The Jobs Optimization Engine 206 executes a multi-objective optimization algorithm to calculate the respective boost factor for one or more premium type job posts. In one embodiment, the Jobs Optimization Engine 206 executes the multi-objective optimization algorithm simultaneously for two or more different member accounts. The job post diversity requirement is a pre-defined requirement that requires a threshold mixture of a first type of job posts and a second type of job post included in the listing of job posts. The potential revenue target is a potential revenue that can be generated by displaying one or more boosted premium type job posts in the select listing of job posts.

At operation 620, based on satisfaction of the job post diversity requirement and the potential revenue target, the Jobs Optimization Engine 206 causes display of the select listing of job posts to the target member account in the social network service.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

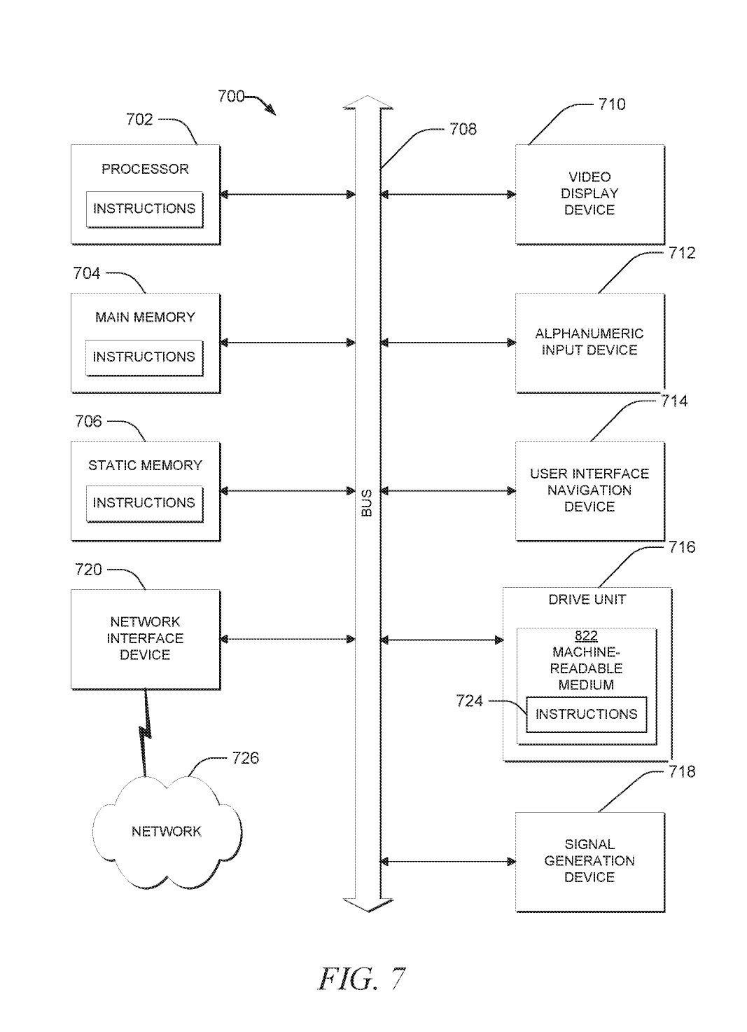

FIG. 7 is a block diagram of an example computer system 700 on which operations, actions and methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 700 includes a processor 702 (e.g., a central processing unit (CPU), a graphics processing unit (GPU) or both), a main memory 704, and a static memory 706, which communicate with each other via a bus 708. Computer system 700 may further include a video display device 710 (e.g., a liquid crystal display (LCD) or a cathode ray tube (CRT)). Computer system 700 also includes an alphanumeric input device 712 (e.g., a keyboard), a user interface (UI) navigation device 714 (e.g., a mouse or touch sensitive display), a disk drive unit 716, a signal generation device 718 (e.g., a speaker) and a network interface device 720.

Disk drive unit 716 includes a machine-readable medium 722 on which is stored one or more sets of instructions and data structures (e.g., software) 724 embodying or utilized by any one or more of the methodologies or functions described herein. Instructions 724 may also reside, completely or at least partially, within main memory 704, within static memory 706, and/or within processor 702 during execution thereof by computer system 700, main memory 704 and processor 702 also constituting machine-readable media.

While machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 724 may further be transmitted or received over a communications network 726 using a transmission medium. Instructions 724 may be transmitted using network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system, comprising:
a processor;
a memory device holding an instruction set executable on the processor to cause the computer system to perform operations comprising:
for a target member account in a plurality of member accounts of a social network service:
accessing at least one respective apply probability that corresponds to a given job post from a plurality of job posts, each respective apply probability representing a likelihood that the target member account will apply to the given job post;
determining, according to an input context and the at least one respective apply probability, a respective boost factor for each given job post based on including the given job post in a select listing of job posts that satisfies (i) a job post diversity requirement and (ii) a potential revenue target that can be generated by the select listing of job posts; and
based on satisfaction of the job post diversity requirement and the potential revenue target, causing display of the select listing of job posts to the target member account in the social network service, wherein a first job post is ranked in the select listing according to a corresponding boost factor.

2. The computer system as in claim 1, further comprises:
wherein the input context comprises one or more profile data attributes of the target member account and at least one keyword of a search query submitted by the target member account.

3. The computer system as in claim 1, further comprising:
wherein the a respective boost factor represents an extent of rank adjustment to be applied to a current rank of a premium type of job post included in the select listing of job posts.

4. The computer system as in claim 3, wherein determining the respective serve probability for each given job post comprises:
executing a multi-objective optimization algorithm to calculate the respective boost factor for one or more premium type job posts.

5. The computer system as in claim 4, wherein executing of a multi-objective optimization comprises:
executing the multi-objective optimization algorithm simultaneously for two or more different member accounts.

6. The computer system as in claim 1, further comprising:
wherein the job post diversity requirement comprises a threshold mixture of a first type of job posts and a second type of job post included in the listing of job posts.

7. The computer system as in claim 6, further comprising:
wherein the first type of job posts comprise premium type job posts, wherein each premium type job post was uploaded to the social network service upon payment of a fee;
wherein the second type of job posts comprise basic type job posts, wherein each basic type job post was uploaded to the social network service for free.

8. The computer system as in claim 7, further comprising:
wherein the potential revenue target comprises a potential revenue that can be generated by one or more of the premium type job post included in the select listing of job posts.

9. A computer-implemented method comprising:
for a target member account in a plurality of member accounts of a social network service:
accessing at least one respective apply probability that corresponds to a given job post from a plurality of job posts, each respective apply probability representing a likelihood that the target member account will apply to the given job post;
determining, according to an input context and the at least one respective apply probability, a respective boost factor for each given job post based on including the given job post in a select listing of job posts that satisfies (i) a job post diversity requirement and (ii) a potential revenue target that can be generated by the select listing of job posts; and
based on satisfaction of the job post diversity requirement and the potential revenue target, causing display of the select listing of job posts to the target member account in the social network service, wherein a first job post is ranked in the select listing according to a corresponding boost factor.

10. The computer-implemented method as in claim 9, further comprises:
wherein the input context comprises one or more profile data attributes of the target member account and at least one keyword of a search query submitted by the target member account.

11. The computer-implemented method as in claim 9, further comprising:
wherein the a respective boost factor represents an extent of rank adjustment to be applied to a current rank of a premium type of job post included in the select listing of job posts.

12. The computer-implemented method as in claim 11, wherein determining the respective serve probability for each given job post comprises:
executing a multi-objective optimization algorithm to calculate the respective boost factor for one or more premium type job posts.

13. The computer-implemented method as in claim 12, wherein executing of a multi-objective optimization comprises:
executing the multi-objective optimization algorithm simultaneously for two or more different member accounts.

14. The computer-implemented method as in claim 9, further comprising:
wherein the job post diversity requirement comprises a threshold mixture of a first type of job posts and a second type of job post included in the listing of job posts.

15. The computer-implemented method as in claim 14 further comprising:
wherein the first type of job posts comprise premium type job posts, wherein each premium type job post was uploaded to the social network service upon payment of a fee;
wherein the second type of job posts comprise basic type job posts, wherein each basic type job post was uploaded to the social network service for free.

16. The computer-implemented method as in claim 15, further comprising:
wherein the potential revenue target comprises a potential revenue that can be generated by one or more of the premium type job post included in the select listing of job posts.

17. A non-transitory computer-readable medium storing executable instructions thereon, which, when executed by a processor, cause the processor to perform operations including:
for a target member account in a plurality of member accounts of a social network service:
accessing at least one respective apply probability that corresponds to a given job post from a plurality of job posts, each respective apply probability representing a likelihood that the target member account will apply to the given job post;
determining, according to an input context and the at least one respective apply probability, a respective boost factor for each given job post based on including the given job post in a select listing of job posts that satisfies (i) a job post diversity requirement and (ii) a potential revenue target that can be generated by the select listing of job posts; and
based on satisfaction of the job post diversity requirement and the potential revenue target, causing display of the select listing of job posts to the target member account in the social network service, wherein a first job post is ranked in the select listing according to a corresponding boost factor.

18. The non-transitory computer-readable medium as in claim 17, further comprises:
wherein the input context comprises one or more profile data attributes of the target member account and at least one keyword of a search query submitted by the target member account.

19. The non-transitory computer-readable medium as in claim 17, further comprises:
wherein the a respective boost factor represents an extent of rank adjustment to be applied to a current rank of a premium type of job post included in the select listing of job posts.

20. The non-transitory computer-readable medium as in claim 17, wherein determining the respective serve probability for each given job post comprises:
executing a multi-objective optimization algorithm to calculate the respective boost factor for one or more premium type job posts.
